(19) United States
(12) Patent Application Publication
(10) Pub. No.: US 2025/0040753 A1
(43) Pub. Date: Feb. 6, 2025

(54) Automated Skewer Grill

(71) Applicants: Sepehre Bigdeli, Mission Viejo, CA (US); Yaser Karbalaiee, Mission Viejo, CA (US)

(72) Inventors: Sepehre Bigdeli, Mission Viejo, CA (US); Yaser Karbalaiee, Mission Viejo, CA (US)

(21) Appl. No.: 18/791,260

(22) Filed: Jul. 31, 2024

Related U.S. Application Data
(60) Provisional application No. 63/516,800, filed on Jul. 31, 2023.

(51) Int. Cl. A47J 37/04; A47J 27/00; A47J 36/32; A47J 43/20; B65G 17/32

(52) U.S. Cl. CPC A47J 37/045; A47J 27/004; A47J 36/32; A47J 37/041; A47J 37/043; A47J 43/20; B65G 17/32

(57) ABSTRACT

An automated skewer grill is an apparatus that can cook several kebabs efficiently, rapidly, and automatically. The apparatus includes a structural frame, a motorized belt conveyor, at least one heating device, a skewer-molding mechanism, a control system, and a power system. The structural frame corresponds to the structure that supports the rest of the components of the apparatus. The motorized belt conveyor enables the automated movement of the desired food products throughout the apparatus. The at least one heating device enables the even and complete cooking of the desired food products carried by the motorized belt conveyor. The skewer-molding mechanism enables the automatic generation of the food products to be carried by the motorized belt conveyor to the at least one heating device. The control system and the power system enable the automated operation of the motorized belt conveyor, the at least one heating device, and the skewer-molding mechanism.

The current application claims a priority to the U.S. provisional patent application Ser. No. 63/516,800 filed on Jul. 31, 2023.

### FIELD OF THE INVENTION

The present invention relates generally to cooking appliances and automated systems. More specifically, the present invention discloses an automated skewer grill that can efficiently and quickly cook several skewers in a shorter period of time.

### BACKGROUND OF THE INVENTION

Several cooking appliances have been made available that facilitate the cooking process for both residential and commercial kitchens. With improvements in technology, many automated cooking appliances have been developed to help people cook more efficiently and rapidly. For example, different electric rice cookers are now available that allow users to cook different types of rice using various cooking techniques. Similarly, many cooking appliances have been developed to cook a greater amount of food products, especially in commercial kitchens. For example, stand grills are available that can cook several food products simultaneously so a greater amount of food products can be cooked in a shorter time. While different appliances have been made available to cook specific food products, few have been made available to help cook food in skewers in large quantities. There are some skewer grills that can accommodate many skewers simultaneously. However, these grills accommodate a very limited number of skewers, which in commercial settings can be inefficient. Therefore, there is a need for a better cooking appliance that can accommodate a greater amount of skewers to cook several food products more efficiently and rapidly.

An objective of the present invention is to provide an automated skewer grill that can efficiently cook several food products on skewers. The present invention is preferably designed to completely and evenly grill several kebabs; however, other products can be accommodated. Another objective of the present invention is to provide an automated skewer grill that can cook food products rapidly at different speeds. The present invention can be adjusted to grill kebabs at different speeds according to the type of food being cooked. Another objective of the present invention is to provide an automated skewer grill that is safe to use and does not generate too much smoke. The present invention can be safely used without specialized training and eliminates the need for a centrifugal hood. Another objective of the present invention is to provide an automated skewer grill that is more energy efficient. The present invention utilizes less gas consumption by implementing other power sources that power specific components. Additional features and benefits of the present invention are further discussed in the sections below.

### SUMMARY OF THE INVENTION

The present invention is an automated skewer grill that can prepare a variety of kebabs that are skewered. The capacity of the present invention ranges from 400 to 1400 skewers per hour. For example, each kebab or food product can be fully cooked in under one second. The present invention does not need an experienced cook, and with simple training, the operator of the present invention can safely operate it. The present invention takes up very little space and operates 100% smoke-free, so there is no need for a centrifugal hood to remove smoke from the kitchen. Further, the gas consumption of the present invention is very low due to the use of radiant heat mechanism and infrared waves, which reduces gas utility costs. The present invention has a steel structure and a housing made of steel sheet, which is fully resistant to heat and steam conditions in industrial kitchens.

In addition, the present invention can accommodate different types of food including, but not limited to, minced kebabs, chicken, fish, etc. Different accessories can be implemented to accommodate different food products. Further, the present invention can be provided in different embodiments that may include different features and capacities that cover all market needs. Commercial automated versions of the present invention can have capacities of 1400, 1200, 1000, 750, and 400 skewers per hour, while manual versions of the present invention can have capacities of 40, 30, 20, 12, and 10 skewers. Further, the user can adjust the working speed of the present invention, the amount of cooking, and the size of the skewers. No hands are involved, and no surfaces are touched by the food product during cooking so that the food product is not carbonated or burned. Furthermore, residential versions of the present invention can be provided that may include different features.

### BRIEF DESCRIPTION OF THE DRAWINGS

FIG. 1 is a side schematic view of the present invention, wherein the external structure of the structural frame is shown.

FIG. 2 is a side schematic view of the present invention, wherein the internal structure of the structural frame is shown, and wherein the elongated skewer mold of the skewer-molding mechanism is shown disengaged.

FIG. 3 is a side schematic view of the present invention, wherein the internal structure of the structural frame is shown, and wherein the fluid connections of the skewer-molding mechanism.

FIG. 4 is a side schematic view of the present invention, wherein the internal structure of the structural frame is shown, and wherein the elongated skewer mold of the skewer-molding mechanism is shown engaged.

FIG. 5 is a side schematic view of the vertical frame portion of the structural frame of the present invention, wherein an alternate embodiment of the motorized belt conveyor is shown with additional upward and downward conveyor sections.

FIG. 6 is a top perspective view of the elongated skewer mold of the present invention, wherein the static mold piece and the dynamic mold piece of the elongated skewer mold are shown.

FIG. 7 is a bottom perspective view of the elongated skewer mold of the present invention, wherein the static mold piece and the dynamic mold piece of the elongated skewer mold are shown.

FIG. 8 is a side schematic view of a skewer clip of the plurality of skewer clips of the present invention.

FIG. 9 is a side schematic view of the skewer-molding mechanism of the present invention, wherein several skewers are shown carried by the corresponding skewer clips on the motorized belt conveyor.

FIG. 10 is a side schematic view of the skewer-molding mechanism of the present invention, wherein a selected skewer on the corresponding skewer clip is shown aligned with the elongated skewer mold.

FIG. 11 is a side schematic view of the skewer-molding mechanism of the present invention, wherein the dynamic mold piece of the elongated skewer mold is shown engaging the selected skewer.

FIG. 12 is a side schematic view of the skewer-molding mechanism of the present invention, wherein the dynamic mold piece of the elongated skewer mold is shown moving the selected skewer against the static mold piece.

FIG. 13 is a side schematic view of the skewer-molding mechanism of the present invention, wherein the selected skewer is shown enclosed by the elongated skewer mold, and wherein the hydraulic pump is shown engaged.

FIG. 14 is a side schematic view of the skewer-molding mechanism of the present invention, wherein the hydraulic pump is shown moving food product into the elongated skewer mold.

FIG. 15 is a block diagram showing the electrical connections and the electronic connections of the present invention, wherein the electrical connections are shown in solid lines, and wherein the electronic connections are shown in dashed lines.

### DETAILED DESCRIPTION OF THE INVENTION

All illustrations of the drawings are for the purpose of describing selected versions of the present invention and are not intended to limit the scope of the present invention.

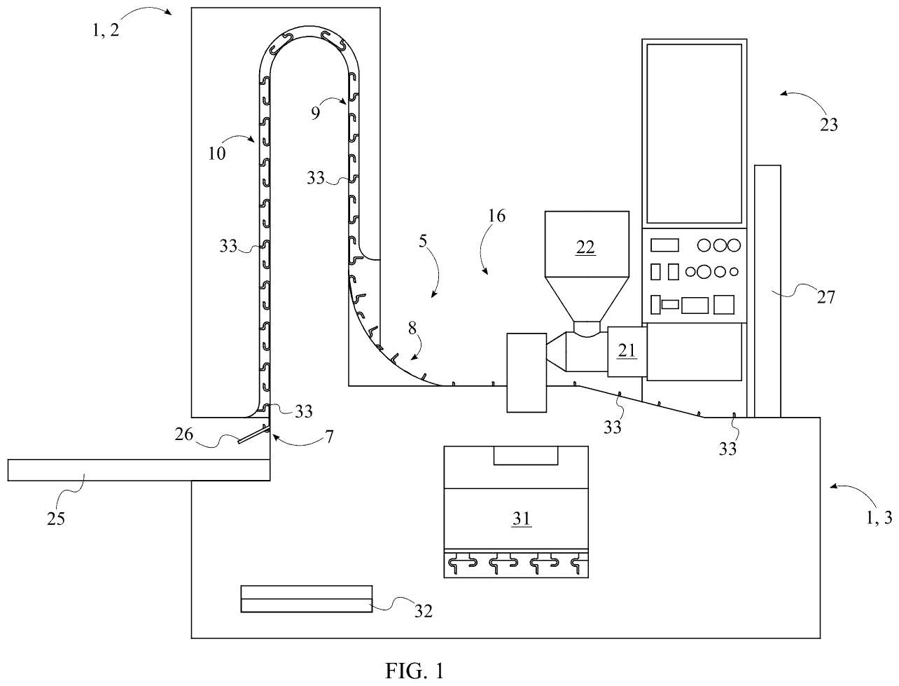

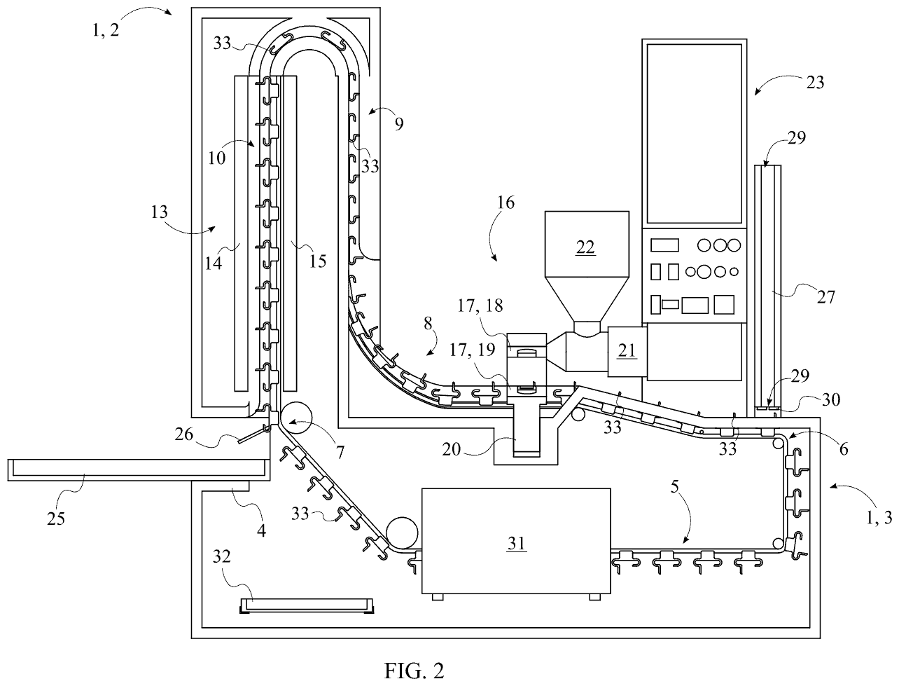

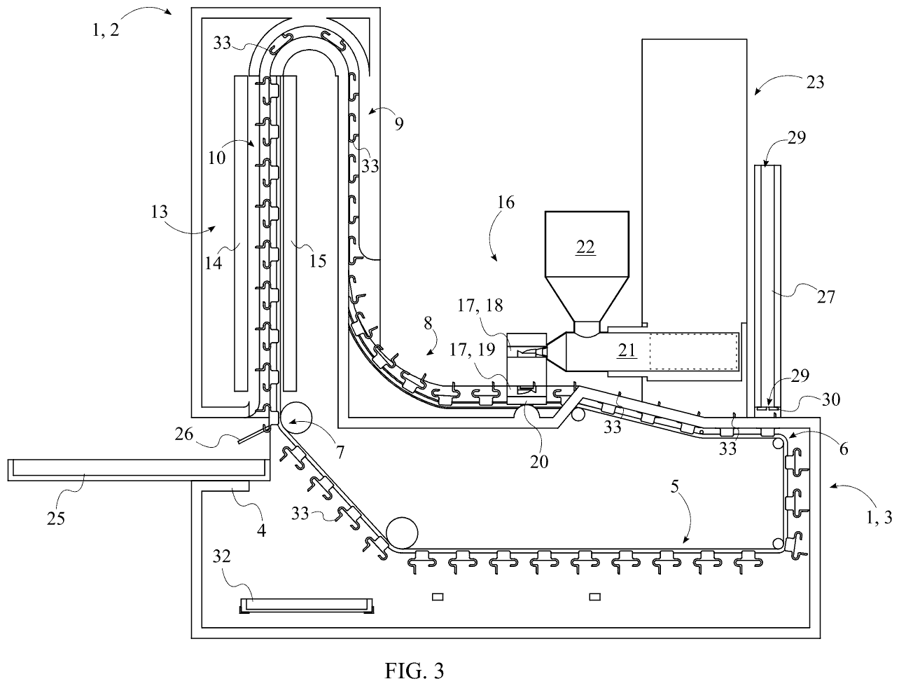

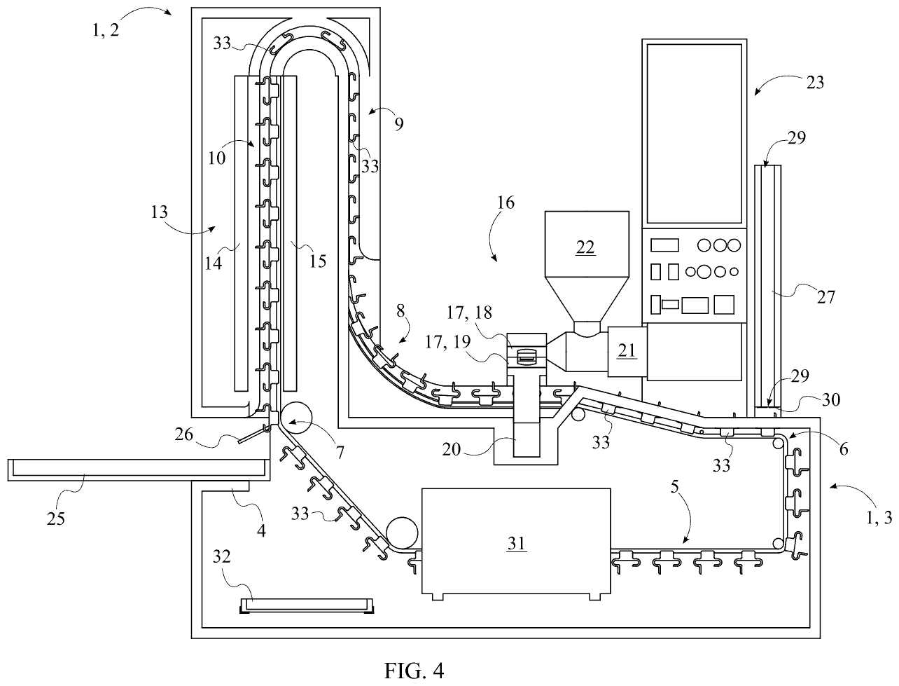

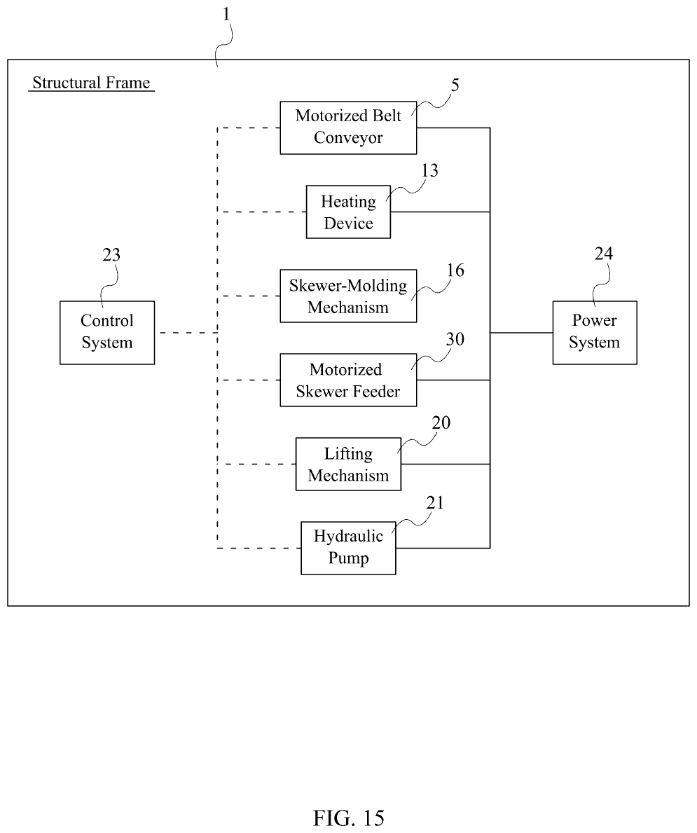

The present invention discloses an automated skewer grill that can cook a large amount of food products efficiently and rapidly. The present invention is preferably designed to cook a large amount of foods on skewers, such as kebabs, but can be modified to cook different food products by utilizing different accessories. As can be seen in FIGS. 1 through 4 and 15, the present invention comprises a structural frame 1, a motorized belt conveyor 5, at least one heating device 13, a skewer-molding mechanism 16, a control system 23, and a power system 24. The structural frame 1 corresponds to the structure that supports the rest of the components of the present invention. The motorized belt conveyor 5 enables the automated movement of the desired food products throughout the present invention. The at least one heating device 13 enables the even and complete cooking of the desired food products carried by the motorized belt conveyor 5. The skewer-molding mechanism 16 enables the automatic generation of the food products to be carried by the motorized belt conveyor 5 to the at least one heating device 13. The control system 23 and the power system 24 enable the automated operation of the motorized belt conveyor 5, the at least one heating device 13, and the skewer-molding mechanism 16.

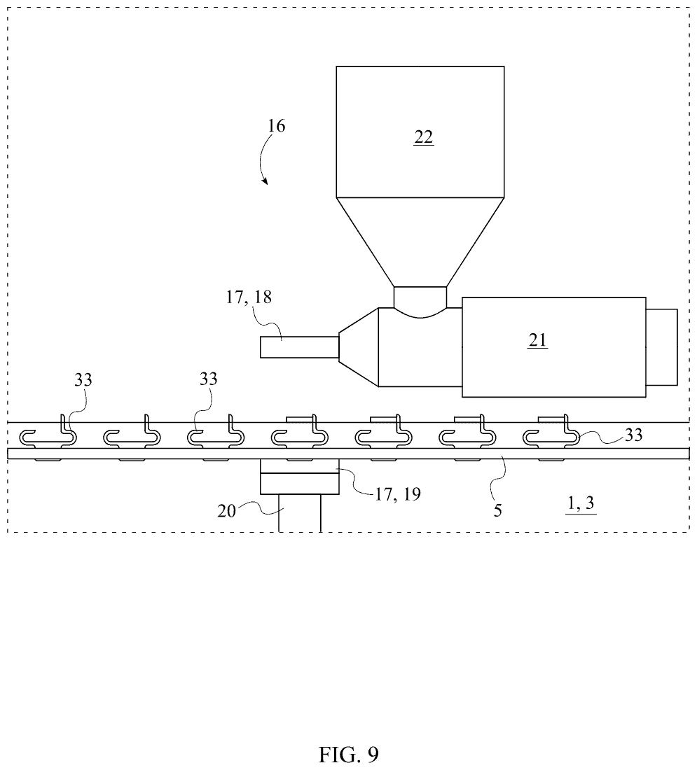

The general configuration of the aforementioned components enables the user to quickly cook several food products in a more efficient and rapid manner without major user input. As can be seen in FIGS. 1 through 4 and 9, the structural frame 1 is designed as a standalone structure that can be transported and installed in the desired location for food preparation. The structural frame 1 is preferably a lightweight structure strong enough to support the rest of the components of the present invention. Further, the structural frame 1 can be modified to accommodate different food cooking capacities as well as different features that allow for different food products to be prepared and cooked. In general, the structural frame 1 comprises a vertical frame portion 2 and a horizontal frame portion 3. The vertical frame portion 2 corresponds to the portion of the structural frame 1 that supports the cooking and dispensing of the food products carried by the motorized belt conveyor 5. On the other hand, the horizontal frame portion 3 corresponds to the portion of the structural frame 1 that supports the loading of the skewers on the motorized belt conveyor 5 as well as the preparation of the desired food products on the skewers. The structural frame 1 may also be covered by light-weight material that isolates several of the components from the surroundings. For example, the vertical frame portion 2 may be covered by heat-resistant material that protects the user from the heat radiating from the at least one heating device 13. Furthermore, the motorized belt conveyor 5 comprises a first conveyor end 6 and a second conveyor end 7 corresponding to the locations where the skewers are loaded onto the motorized belt conveyor 5 and where the skewers with the cooked food products are offloaded, respectively.

In the preferred embodiment, the present invention can be arranged as follows: the vertical frame portion 2 is terminally positioned to the horizontal frame portion 3 to form an overall L-shaped structure, as can be seen in FIGS. 1 through 4 and 15. The motorized belt conveyor 5 is mounted along the horizontal frame portion 3 and about the vertical frame portion 2 so that skewers with food product carried by the motorized belt conveyor 5 move from the horizontal frame portion 3 to the vertical frame portion 2. Further, the first conveyor end 6 is terminally positioned to the horizontal frame portion 3, opposite to the vertical frame portion 2. In addition, the second conveyor end 7 is laterally positioned to the vertical frame portion 2, opposite to the horizontal frame portion 3. This way, the motorized belt conveyor 5 spans the entire length of the structural frame 1 to move the skewers with the desired food products from the horizontal frame portion 3 to the vertical frame portion 2.

As can be seen in FIGS. 1 through 4 and 15, furthermore, the at least one heating device 13 is mounted onto the vertical frame portion 2 to secure the at least one heating device 13 within the structural frame 1. In addition, the at least one heating device 13 is positioned along the motorized belt conveyor 5, adjacent to the second conveyor end 7. This way, as the skewers with the desired food products are moved by the motorized belt conveyor 5 around the vertical frame portion 2, the food products are evenly and completely cooked by the at least one heating device 13. On the other hand, the skewer-molding mechanism 16 is laterally mounted to the horizontal frame portion 3 to secure the skewer-molding mechanism 16 to the structural frame 1. In addition, the skewer-molding mechanism 16 is positioned along the motorized belt conveyor 5, offset from the first conveyor end 6. This way, once the skewers or other appropriate food accessories are loaded adjacent to the first conveyor end 6, the motorized belt conveyor 5 moves the skewers to the skewer-molding mechanism 16 to apply the desired food products onto the skewers. Then, the skewers with the desired food products are moved by the motorized belt conveyor 5 to the vertical frame portion 2 so that the food products are cooked by the at least one heating device 13. Further, the motorized belt conveyor 5, the at least one heating device 13, and the skewer-molding mechanism 16 are electronically connected to the control system 23. The control system 23 is designed to control the automatic operation of each component under preset configurations. For example, the user can set the speed of the motorized belt conveyor 5, the amount of food product applied to each skewer, the cooking temperature of the at least one heating device 13, etc. Furthermore, the motorized belt conveyor 5 and the at least one heating device 13 are electrically connected to the power system 24 to provide the voltage necessary for the operation of each component. For example, the power system 24 can be configured to enable the connection of the present invention to an external electricity utility. In other embodiments, the present invention can be rearranged to meet specific requirements or to accommodate other features.

As previously discussed, the present invention is preferably designed as an automated device that operates under predetermined settings and configurations. As can be seen in FIGS. 1 through 4 and 15, to enable the user to configure the operation of the different components, the control system 23 may include a controller and a user interface. The controller corresponds to the computing device able to process and store the user's settings that allow for the automated operation of the present invention. The user interface allows the user to configure the different operational settings of the present invention. The controller and the user interface can be provided in a controller compartment for ease of access to the user. The controller compartment can be mounted onto the horizontal frame portion 3, adjacent to the first conveyor end 6, to secure the controller compartment to the structural frame 1. In addition, the controller can be mounted within the controller compartment, while the user interface is externally integrated onto the controller compartment to allow access to the different features of the user interface. For example, the user interface may include a timer, a start button, a power switch, a skewer motor switch, a grill motor switch, a heater switch, a conveyor speed knob, a directional switch, a loading-selection switch, a vertical jack switch, a horizontal jack switch, a mold temperature selector, a kebab weight selector, etc. Further, the motorized belt conveyor 5, the at least one heating device 13, the skewer-molding mechanism 16, and the user interface are electronically connected to the controller to enable the transmission of the generated signals.

Furthermore, additional automation features can be implemented to help the user control the cooking of the desired food products. In some embodiments, the control system 23 may further include a plurality of sensors and monitoring devices to help monitor the operation of the present invention. For example, the control system 23 can include computer vision, infrared & thermal cameras, and other general-purpose sensors to monitor and adjust all the operational settings of the present invention, ensuring quality control. Further, the control system 23 can enable the user to adjust the cooking temperature based on food type and quality. The different heating devices can be adjusted to heat under different temperatures along the motorized belt conveyor 5 for varied cooking. In addition, the present invention can implement automatic packaging of the cooked food products after being unloaded from the motorized belt conveyor 5. In addition, the control system 23 further incorporates an automated customizable web and cloud control center for easy management and control. Further, a human-less kiosk system can be integrated for automated order placement and delivery to customers. In addition, the present invention can implement a cleaning mechanism for automated or semi-automated maintenance of the different features of the present invention. The motorized belt conveyor 5 can further include a rotation mechanism to rotate the skewers for even cooking.

Further, as previously discussed, the control system 23 can implement various sensors and monitoring devices that could enable the implementation of smart for real-time feedback on cooking progress and temperature. The control system 23 may also include wireless communication technologies that allows the user to operate and monitor via the present invention from an external computing device by implementing a corresponding software application. Further, the structural frame 1 of the present invention can include a modular design that enables the user to easily replace or upgrade individual components. Further, the heating mechanism of the present invention enables energy recovery by recycling heat to enhance energy efficiency. Further, the structural frame 1 can enable the integration with other kitchen appliances so that the control system 23 can coordinate with other automated kitchen appliances. Further, the present invention includes several safety features including, but not limited to, an automatic shutoff, emergency stop buttons, childproof controls, etc. The control system 23 may further allow the integration of a Point of Sales (POS) system that enables seamless order processing and automated cooking in commercial settings. The controller can store several pre-programmed cooking recipes. Further, the control system 23 can implement security measures such as user authentication to restrict the user interface access to only authorized personnel. Furthermore, the power system 24 can include a backup power system 24 that ensures continued operation during power outages. In other embodiments, different control and automation features can be implemented to help control different operational settings of the present invention.

As previously discussed, the present invention implements a heating mechanism that completely and evenly cooks the desired food products in a more energy-efficient manner without generating smoke. In some embodiments, the at least one heating device 13 can be a gas-fired radiant heater. The gas-fired radiant heater cooks the desired food products using induction heating mechanisms, transferring heat deep into the meat. The heat is generated from fine flame sources on the burner surface, causing a ceramic surface to melt, releasing infrared waves. The gas-fired radiant heater ensures a thoroughly cooked kebab while preventing Carbon Dioxide (CO2) meat poisoning. Further, an essential aspect of the gas-fired radiant heater is the strategic top-down heating orientation on the vertical frame portion 2, resulting in a uniform temperature across the cooking surface. In other embodiments, different heating mechanisms can be implemented to cook different food products.

In some embodiments, the present invention includes means to collect the cooked food products after being offloaded from the motorized belt conveyor 5. As can be seen in FIGS. 1 through 4 and 15, the present invention may further comprise a collection tray 25 that collects the cooked food products in a safe and hygienic manner. In addition, the structural frame 1 may further comprise a tray receptacle 4 that accommodates the collection tray 25 in such a manner that the user can replace a full collection tray 25 with an empty one. To implement the collection tray 25 and the tray receptacle 4, the tray receptacle 4 is integrated into the vertical frame portion 2, adjacent to the second conveyor end 7. This way, the tray receptacle 4 is positioned adjacent to the second conveyor end 7 where the cooked food products are offloaded from the motorized belt conveyor 5. For example, the tray receptacle 4 can be a flat structure integrated into the structural frame 1 with a size and shape that accommodate the collection tray 25. Furthermore, the collection tray 25 can be situated into the tray receptacle 4 to collect the cooked food products from the motorized belt conveyor 5. In other embodiments, different collection mechanisms can be implemented to safely and hygienically collect the cooked food products.

As previously discussed, the cooked food products are offloaded at the second conveyor end 7 onto the collection tray 25. Due to the vertical orientation of the motorized belt conveyor 5 on the vertical frame portion 2, the cooked food products would naturally fall off the motorized belt conveyor 5 and not into the collection tray 25. As can be seen in FIGS. 1 through 4 and 15, the present invention may further comprise a plurality of skewer-releasing guide rods 26 that facilitate the controlled offloading of the cooked food products from the motorized belt conveyor 5 onto the collection tray 25. The plurality of skewer-releasing guide rods 26 is designed to facilitate the disengagement of the skewers carrying the cooked food products from the motorized belt conveyor 5. In addition, the plurality of skewer-releasing guide rods 26 guide the falling skewers carrying the cooked food products towards the collection tray 25. To do so, each of the plurality of skewer-releasing guide rods 26 is integrated into the motorized belt conveyor 5 in between the at least one heating device 13 and the second conveyor end 7. For example, two skewer-releasing guide rods can be implemented, each being positioned on opposite sides of the motorized belt conveyor 5. In addition, the two skewer-releasing guide rods are positioned so that the skewer-releasing guide rods strike the ends of the skewers on the motorized belt conveyor 5 to release the skewers from the motorized belt conveyor 5. Further, each of the plurality of skewer-releasing guide rods 26 is oriented towards the collection tray 25 to guide the falling skewers carrying the cooked food products towards the collection tray 25. In other embodiments, different mechanisms can be implemented to release the skewers from the motorized belt conveyor 5 and guide the skewers towards the collection tray 25 or other collection mechanisms.

As can be seen in FIGS. 1 through 4 and 15, the present invention is preferably implemented as a fully automated system that reduces the user input. So, the present invention may further comprise a skewer magazine 27 that allows for the automated loading of clean skewers onto the motorized belt conveyor 5. The skewer magazine 27 includes a structure designed to retain a determined amount of clean skewers that can be transported by the motorized belt conveyor 5. Further, the skewer magazine 27 comprises a magazine inlet 28 and a magazine outlet 29. The magazine inlet 28 corresponds to the structure of the skewer magazine 27 that allows the insertion of clean skewers into the skewer magazine 27. The magazine outlet 29 corresponds to the structure of the skewer magazine 27 through which the clean skewers are dispensed onto the motorized belt conveyor 5. In the preferred embodiment, the skewer magazine 27 can be implemented as follows: the magazine inlet 28 is positioned opposite to the magazine outlet 29 about the skewer magazine 27 due to the overall elongated shape of the skewer magazine 27. Further, the skewer magazine 27 is mounted onto the horizontal frame portion 3, adjacent to the first conveyor end 6, so that the dispensed skewers are dispensed close to the first conveyor end 6. In addition, the magazine inlet 28 is oriented away from the motorized belt conveyor 5 to facilitate the insertion of clean skewers into the skewer magazine 27. Furthermore, the magazine outlet 29 is oriented towards the motorized belt conveyor 5 so that the dispensed skewers fall onto the motorized belt conveyor 5.

As can be seen in FIGS. 1 through 4 and 15, in some embodiments, the present invention can include means to control the dispensing of clean skewers onto the motorized belt conveyor 5. For example, the present invention may further comprise a motorized skewer feeder 30 that dispenses clean skewers at the same rate as the speed of the motorized belt conveyor 5. The motorized skewer feeder 30 can be a hinged gate that is actuated by a motor to enable the controlled dispensing of the clean skewers. To implement the motorized skewer feeder 30, the motorized skewer feeder 30 is integrated into the magazine outlet 29, so the dispensing of clean skewers is controlled at the magazine outlet 29. Further, the motorized skewer feeder 30 is electronically connected to the control system 23 so that the operation of the motorized skewer feeder 30 can be controlled by the control system 23. Furthermore, the motorized skewer feeder 30 is electrically connected to the power system 24 to receive the power necessary for the automated operation of the motorized skewer feeder 30. In other embodiments, different automated mechanisms can be implemented to control the dispensing of clean skewers onto the motorized belt conveyor 5.

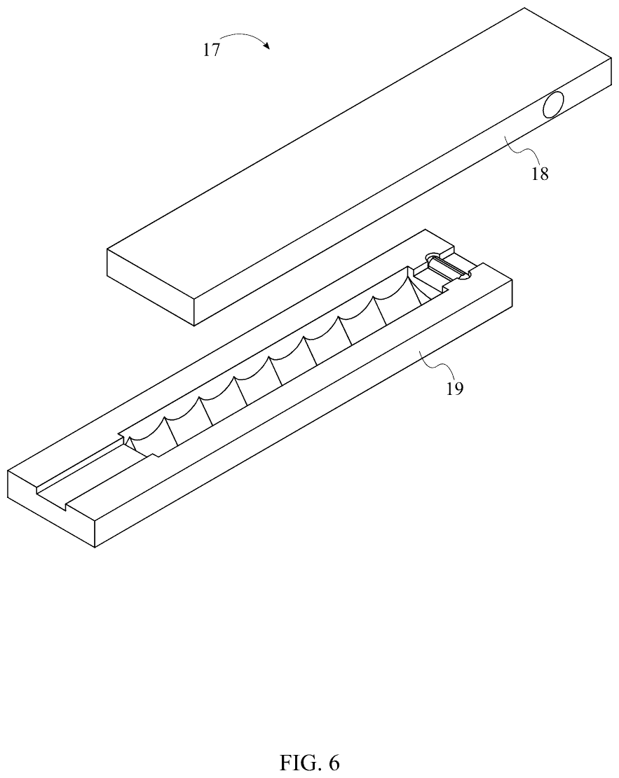

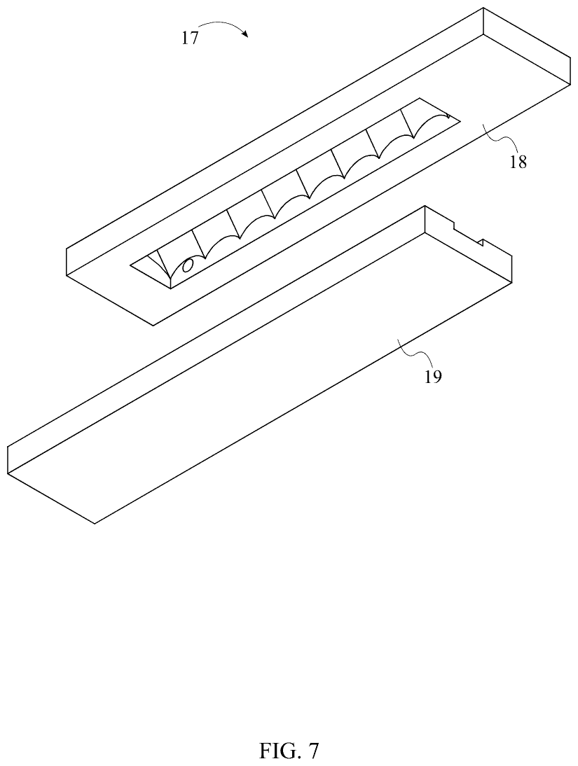

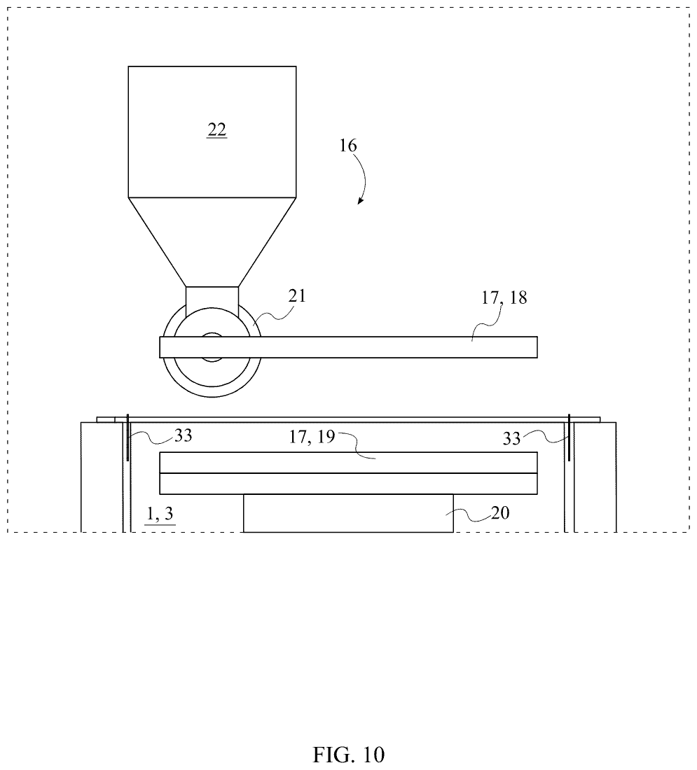

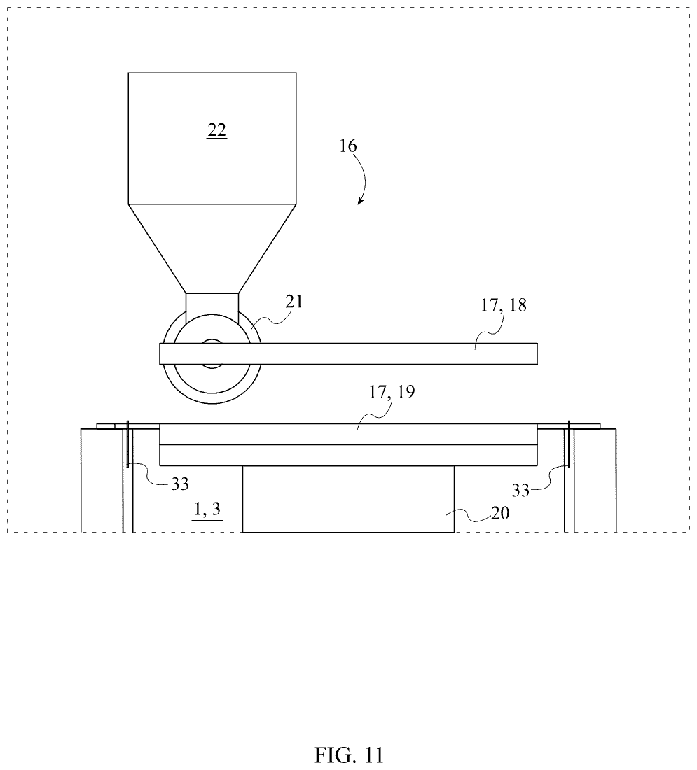

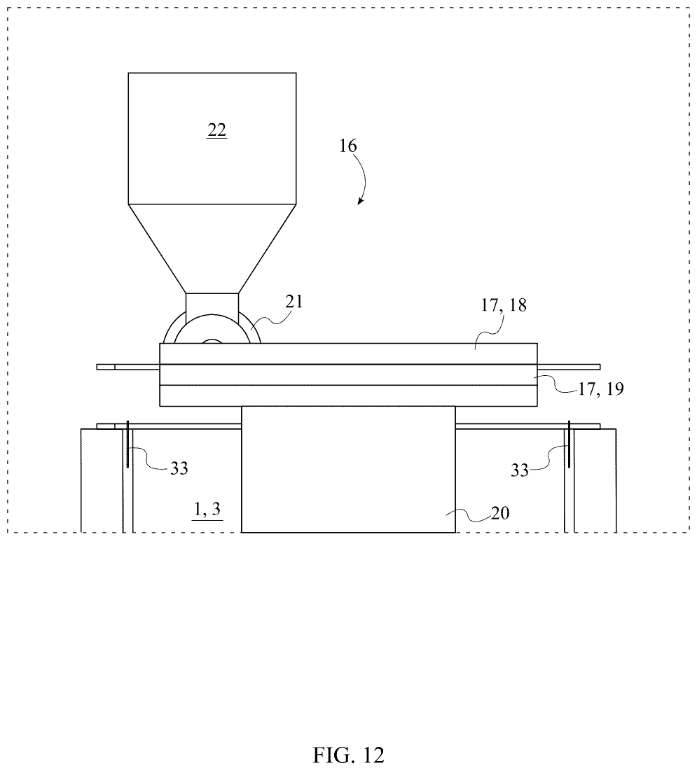

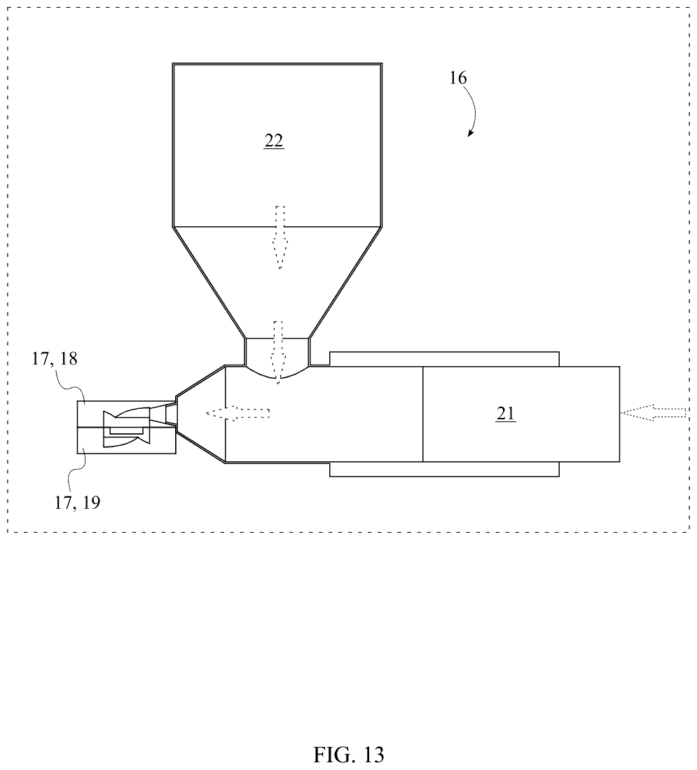

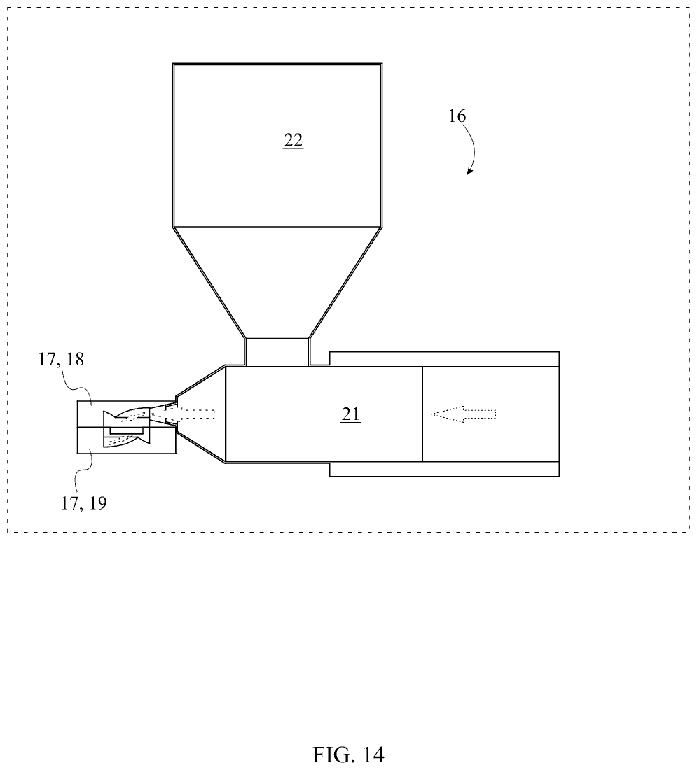

As previously discussed, the skewer-molding mechanism 16 facilitates the automated dispensing of the desired food products onto the clean skewers. As can be seen in FIGS. 1 through 4, 6, 7, and 9 through 15, the skewer-molding mechanism 16 preferably includes a mold structure that forms the desired food structure into a predetermined shape on the corresponding clean skewer. So, the skewer-molding mechanism 16 may comprise an elongated skewer mold 17 and a lifting mechanism 20. The elongated skewer mold 17 is preferably a mold structure that shapes the desired food product into a kebab on the skewer. However, other mold structures can be implemented to shape the desired food products into different shapes on different devices. Further, the lifting mechanism 20 enables the actuation of the elongated skewer mold 17 to dispense the desired food product on the clean skewers. Furthermore, the elongated skewer mold 17 comprises a static mold piece 18 and a dynamic mold piece 19. The static mold piece 18 and the dynamic mold piece 19 are designed to shape the dispensed food product into a kebab on the corresponding skewer. The static mold piece 18 and the dynamic mold piece 19 can be made from durable materials including, but not limited to, Aluminum, cast iron, steel, etc., and are hygienically coated with ceramics.

As can be seen in FIGS. 1 through 4, 6, 7, and 9 through 15, in the preferred embodiment, the skewer-molding mechanism 16 can be implemented as follows: the elongated skewer mold 17 is positioned perpendicular to the motorized belt conveyor 5 to match the positioning of the clean skewers on the motorized belt conveyor 5. Further, the static mold piece 18 is mounted onto the horizontal frame portion 3, offset from the first conveyor end 6, so that the static mold piece 18 is positioned above the clean skewers on the motorized belt conveyor 5. On the other hand, the dynamic mold piece 19 is operatively mounted onto the horizontal frame portion 3 by the lifting mechanism 20. The lifting mechanism 20 is used to press the dynamic mold piece 19 against the static mold piece 18. For example, the lifting mechanism 20 can be one or more linear actuators oriented vertically to lift the dynamic mold piece 19 towards the static mold piece 18. In addition, the dynamic mold piece 19 is positioned under the motorized belt conveyor 5 so that the dynamic mold piece 19 carries the skewer positioned above the dynamic mold piece 19 towards the static mold piece 18. This way, the dispensed food product is molded around the skewer when the skewer is moved by the dynamic mold piece 19 towards the static mold piece 18. Furthermore, the lifting mechanism 20 is electronically connected to the control system 23 and is electrically connected to the power system 24. This way, the operation of the lifting mechanism 20 can be automated along with the rest of the present invention.

As can be seen in FIGS. 1 through 4, 6, 7, and 9 through 15, the dispensing of the desired food products into the elongated skewer mold 17 can be done with different mechanisms. In the preferred embodiment, the food product is injected into the elongated skewer mold 17 using a hydraulic mechanism. So, the skewer-molding mechanism 16 may further comprise a hydraulic pump 21 and a food reservoir 22. The food reservoir 22 corresponds to a structure large enough to retain a quantity of food product that is used to make the kebabs. The hydraulic pump 21 enables the injection of the food product into the elongated skewer mold 17. The hydraulic pump 21 and the food reservoir 22 can be implemented as follows: the hydraulic pump 21 and the food reservoir 22 are mounted onto the horizontal frame portion 3, adjacent to the elongated skewer mold 17, so that the hydraulic pump 21 and the food reservoir 22 are secured to the structural frame 1. Further, the food reservoir 22 is in fluid communication with the elongated skewer mold 17 through the hydraulic pump 21. In other words, the hydraulic pump 21 moves an appropriate amount of food product from the food reservoir 22 into the elongated skewer mold 17 where the food product is shaped into a kebab. Furthermore, the hydraulic pump 21 is electronically connected to the control system 23 and is electrically connected to the power system 24. This way, the operation of the hydraulic pump 21 can be automated along with the rest of the present invention.

As can be seen in FIGS. 1 through 4 and 15, in some embodiments, the present invention may further comprise a hydraulic fluid tank 31 to enable the operation of the hydraulic pump 21. So, the hydraulic fluid tank 31 is mounted within the horizontal frame portion 3 to secure the hydraulic fluid tank 31 to the structural frame 1. Further, the hydraulic fluid tank 31 is in fluid communication with the hydraulic pump 21 to allow the flow of the hydraulic fluid between the hydraulic fluid tank 31 and the hydraulic pump 21. Furthermore, the food reservoir 22 and/or the elongated skewer mold 17 can be heated and/or cooled via corresponding heating elements to increase the freshness of the food product. In other embodiments, different features can be implemented to automate the preparation of different food products.

As previously discussed, the motorized belt conveyor 5 is designed to go around the top portion of the vertical frame portion 2. As can be seen in FIGS. 1 through 4, to accommodate the vertical arrangement of the vertical frame portion 2, the motorized belt conveyor 5 may further comprise a slanted transition conveyor section 8, a first upward conveyor section 9, and a first downward conveyor section 10. The slanted transition conveyor section 8 corresponds to the section located after the skewer-molding mechanism 16. The first upward conveyor section 9 and the first downward conveyor section 10 correspond to the opposite sections of the motorized belt conveyor 5 around the peak of the vertical frame portion 2. So, the slanted transition conveyor section 8, the first upward conveyor section 9, and the first downward conveyor section 10 are serially positioned along the motorized belt conveyor 5. In other words, the skewers with the molded food product move from the slanted transition conveyor section 8, through the first upward conveyor section 9, and to the first downward conveyor section 10. Further, the slanted transition conveyor section 8, the first upward conveyor section 9, and the first downward conveyor section 10 are positioned in between the skewer-molding mechanism 16 and the second conveyor end 7. This way, skewers with the molded food products are moved from the skewer-molding mechanism 16 to the second conveyor end 7. Furthermore, the at least one heating device 13 is in thermal communication with the first downward conveyor section 10 so that the molded food product on the corresponding skewers is completely and evenly cooked as the skewers move along the first downward conveyor section 10.

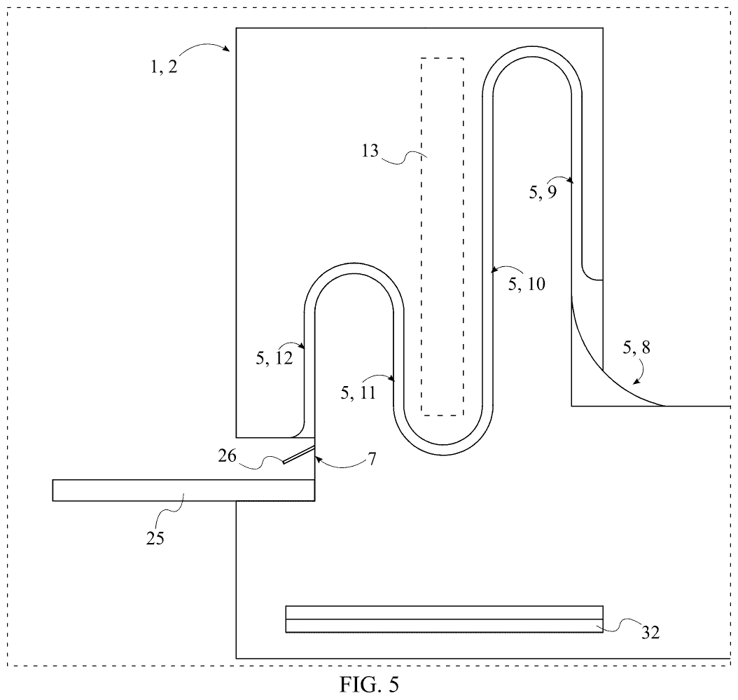

As can be seen in FIGS. 1 through 5, in some embodiments, to accommodate a larger number of skewers so more molded food products are properly cooked in a rapid manner, the motorized belt conveyor 5 may further comprise a second upward conveyor section 11 and a second downward conveyor section 12. The second upward conveyor section 11 and the second downward conveyor section 12 are serially positioned along the motorized belt conveyor 5 to provide more space for the molded food products to properly and rapidly cook. Further, the second upward conveyor section 11 and the second downward conveyor section 12 are positioned in between the first downward conveyor section 10 and the second conveyor end 7. This way, the skewers on the motorized belt conveyor 5 move from the first downward conveyor section 10 to the second upward conveyor section 11 and then towards the second downward conveyor section 12. Furthermore, the at least one heating device 13 is in thermal communication with the second upward conveyor section 11. This way, the molded food products on the skewers are cooked along the first downward conveyor section 10 and the second upward conveyor section 11. In other embodiments, different vertical arrangements can be implemented to cook a greater amount of food products.

The cooking of the food products on the skewers carried by the motorized belt conveyor 5 can generate waste that fall down the structural frame 1, such as meat juices. As can be seen in FIGS. 1 through 5, to collect the food waste generated by the cooking of the food products, the present invention may further comprise a waste collection tray 32 that prevent food waste to maintain a hygienic cooking environment. So, the waste collection tray 32 is mounted onto the vertical frame portion 2, offset from the motorized belt conveyor 5, to secure the waste collection tray 32 to the structural frame 1. The waste collection tray 32 can be removed to dispose of the collected food waste. Furthermore, the waste collection tray 32 is positioned in between the first upward conveyor section 9 and the second conveyor end 7 so that all the food waste generated during the cooking of the food products is collected. In other embodiments, different waste collection mechanisms can be implemented.

As can be seen in FIGS. 1 through 4 and 15, to completely and evenly the molded food product on the skewers carried by the motorized belt conveyor 5, the at least one heating device 13 can be designed to surround the food product for even cooking. So, the at least one heating device 13 may comprise a first heating portion 14 and a second heating portion 15 that can be arranged to surround the molded food products. To do so, the first heating portion 14 is positioned adjacent to the motorized belt conveyor 5. On the other hand, the second heating portion 15 is positioned adjacent to the motorized belt conveyor 5, opposite to the first heating portion 14. This way, the first heating portion 14 and the second heating portion 15 surround the motorized belt conveyor 5 to evenly cook the molded food product on the skewers. In other embodiments, different arrangements of the at least one heating device 13 can be implemented to cook different food products with different cooking techniques.

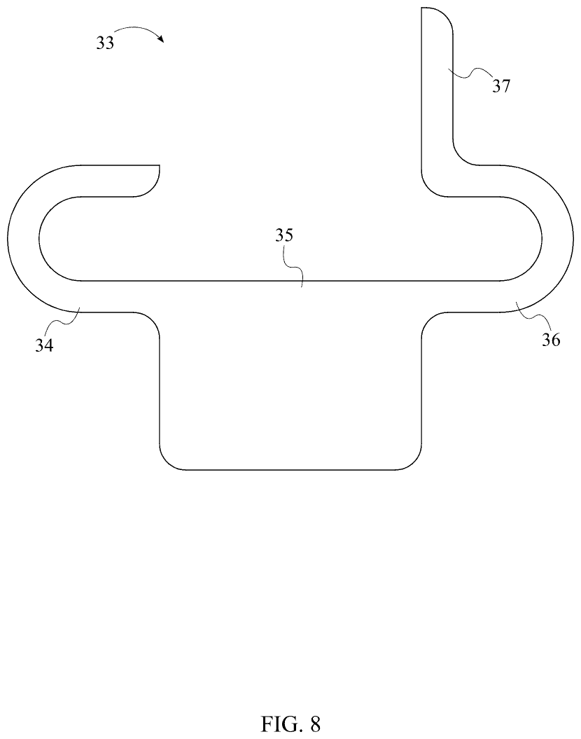

Due to the overall structure of the structural frame 1, the motorized belt conveyor 5 is designed to securely retain the skewers in such a way that the skewers can be temporarily retrieved by the skewer-molding mechanism 16, securely held while moving around the vertical frame portion 2, and then easily released when dispensed onto the collection tray 25. As can be seen in FIGS. 1 through 4, 8, and 9, the present invention may further comprise a plurality of skewer clips 33 that secure the skewers to the motorized belt conveyor 5. The plurality of skewer clips 33 is designed to enable the controlled movement of the skewers at different locations along the motorized belt conveyor 5 while being kept secured to the motorized belt conveyor 5. To do so, each of the plurality of skewer clips 33 is connected onto the motorized belt conveyor 5 to secure the plurality of skewer clips 33 to the motorized belt conveyor 5. Furthermore, the plurality of skewer clips 33 is evenly distributed along the motorized belt conveyor 5 to accommodate several skewers along the motorized belt conveyor 5.

As previously discussed, the plurality of skewer clips 33 enable some movement of the retained skewers at different locations along the motorized belt conveyor 5. As can be seen in FIGS. 1 through 4, 8, and 9, each of the plurality of skewer clips 33 may comprise a C-shaped clip section 34, an intermediate clip section 35, a reverse-C-shaped clip section 36 34, and an extension clip section 37. The C-shaped clip section 34, the intermediate clip section 35, and the reverse-C-shaped clip section 36 34 form the main structure of each skewer clip. The extension clip section 37 enables the controlled placement of each skewer on the corresponding skewer clip. In the preferred embodiment, the extension clip section 37 is positioned perpendicular to the intermediate clip section 35 so that the extension clip section 37 protrudes vertically in relation to the intermediate clip section 35. Further, the intermediate clip section 35 is connected in between the C-shaped clip section 34 and the reverse-C-shaped clip section 36 34 to form an overall C-shaped clip. In addition, the extension clip section 37 is connected onto the reverse-C-shaped section. The extension clip section 37 and the intermediate clip section 35 are also positioned offset from each other about the reverse-C-shaped section. This way, the extension clip provides a guide to each skewer to fall into the skewer clip after passing through the horizontal frame portion 3.

As can be seen in FIGS. 1 through 4 and 8 through 14, in the preferred embodiment, the motorized belt conveyor 5 can be implemented as follows: the horizontal frame portion 3 may include a flat surface that is positioned above the motorized belt conveyor 5. The extension clip portion of each of the plurality of skewer clips 33 protrudes past the top surface of the horizontal frame portion 3 to engage the skewers. For example, when a skewer is dispensed from the skewer magazine 27, the skewer falls onto the flat surface of the horizontal frame portion 3. Then, the extension clip section 37 of the corresponding skewer clip engages and drags the skewer towards the skewer-molding mechanism 16. When the skewer reaches the skewer-molding mechanism 16, the skewer is lifted to mold the food product with the elongated skewer mold 17 enclosing the skewer. Once the food product is molded on the skewer, the skewer is lowered onto the flat surface so that the extension clip section 37 of the corresponding skewer clips move the skewer with the molded food product towards the vertical frame portion 2. As the skewer with the molded food product reaches the vertical frame portion 2, the motorized belt conveyor 5 raises to elevate the skewer. As the skewer moves along the slanted transition conveyor section 8, the skewer falls onto the intermediate clip section 35. Once the skewer is raised high enough to reach the first upward conveyor section 9, an edge of the skewer falls within the reverse-C-shaped clip section 36 34 to securely hold the skewer and the molded food product along the first upward conveyor section 9.

As can be seen in FIGS. 1 through 4 and 8 through 14, as the skewer moves around the peak of the vertical frame portion 2, the skewer moves towards the intermediate clip section 35. Once the skewer moves down the first downward conveyor section 10, the skewer falls into the C-shaped clip section 34 to securely hold the skewer along the first downward conveyor section 10. This way, the molded food product on the skewer is securely held while being cooked along the first downward conveyor section 10. In embodiments that implement the second upward conveyor section 11 and the second downward conveyor section 12, the process is repeated. Once the skewer reaches the second conveyor end 7, the skewer engages the corresponding skewer-releasing guide rod. The skewer-releasing guide rod pushes the skewer upwards from the C-shaped clip section 34 until the skewer reaches the intermediate clip section 35. Then, due to gravity and the weight of the cooked food product on the skewer, the skewer falls off the skewer clip onto the collection tray 25. In other embodiments, different skewer clips or arrangements of the motorized belt conveyor 5 can be implemented to accommodate different cooking methods. Alternatively, the skewers can be replaced with other appropriate tools to retain different products such as chicken or fish.

Although the invention has been explained in relation to its preferred embodiment, it is to be understood that many other possible modifications and variations can be made without departing from the spirit and scope of the invention.

What is claimed is:

1. An automated skewer grill comprising:
a structural frame;
a motorized belt conveyor;
at least one heating device;
a skewer-molding mechanism;
a control system;
a power system;
the structural frame comprising a vertical frame portion and a horizontal frame portion;
the motorized belt conveyor comprising a first conveyor end and a second conveyor end;
the vertical frame portion being terminally positioned to the horizontal frame portion;
the motorized belt conveyor being mounted along the horizontal frame portion and about the vertical frame portion;
the first conveyor end being terminally positioned to the horizontal frame portion, opposite to the vertical frame portion;
the second conveyor end being laterally positioned to the vertical frame portion, opposite to the horizontal frame portion;
the at least one heating device being mounted onto the vertical frame portion;
the at least one heating device being positioned along the motorized belt conveyor, adjacent to the second conveyor end;
the skewer-molding mechanism being laterally mounted to the horizontal frame portion;
the skewer-molding mechanism being positioned along the motorized belt conveyor, offset from the first conveyor end;
the motorized belt conveyor, the at least one heating device, and the skewer-molding mechanism being electronically connected to the control system; and
the motorized belt conveyor and the at least one heating device being electrically connected to the power system.

2. The automated skewer grill as claimed in claim 1, wherein the at least one heating device is a gas-fired radiant heater.

3. The automated skewer grill as claimed in claim 1 further comprising:
a collection tray;
the structural frame further comprising a tray receptacle;
the tray receptacle being integrated into the vertical frame portion, adjacent to the second conveyor end; and
the collection tray being situated into the tray receptacle.

4. The automated skewer grill as claimed in claim 3 further comprising:
a plurality of skewer-releasing guide rods;
each of the plurality of skewer-releasing guide rods being integrated into the motorized belt conveyor in between the at least one heating device and the second conveyor end; and
each of the plurality of skewer-releasing guide rods being oriented towards the collection tray.

5. The automated skewer grill as claimed in claim 1 further comprising:
a skewer magazine;
the skewer magazine comprising a magazine inlet and a magazine outlet;
the magazine inlet being positioned opposite to the magazine outlet about the skewer magazine;
the skewer magazine being mounted onto the horizontal frame portion, adjacent to the first conveyor end;
the magazine inlet being oriented away from the motorized belt conveyor; and
the magazine outlet being oriented towards the motorized belt conveyor.

6. The automated skewer grill as claimed in claim 5 further comprising:
a motorized skewer feeder;
the motorized skewer feeder being integrated into the magazine outlet;
the motorized skewer feeder being electronically connected to the control system; and
the motorized skewer feeder being electrically connected to the power system.

7. The automated skewer grill as claimed in claim 1 further comprising:
the skewer-molding mechanism comprising an elongated skewer mold and a lifting mechanism;
the elongated skewer mold comprising a static mold piece and a dynamic mold piece;
the elongated skewer mold being positioned perpendicular to the motorized belt conveyor;
the static mold piece being mounted onto the horizontal frame portion, offset from the first conveyor end;
the dynamic mold piece being operatively mounted onto the horizontal frame portion by the lifting mechanism, wherein the lifting mechanism is used to press the dynamic mold piece against the static mold piece;
the lifting mechanism being electronically connected to the control system; and
the lifting mechanism being electrically connected to the power system.

8. The automated skewer grill as claimed in claim 7 further comprising:
the skewer-molding mechanism further comprising a hydraulic pump and a food reservoir;
the hydraulic pump and the food reservoir being mounted onto the horizontal frame portion, adjacent to the elongated skewer mold;
the food reservoir being in fluid communication with the elongated skewer mold through the hydraulic pump;
the hydraulic pump being electronically connected to the control system; and
the hydraulic pump being electrically connected to the power system.

9. The automated skewer grill as claimed in claim 8 further comprising:
a hydraulic fluid tank;
the hydraulic fluid tank being mounted within the horizontal frame portion; and
the hydraulic fluid tank being in fluid communication with the hydraulic pump.

10. The automated skewer grill as claimed in claim 1 further comprising:
the motorized belt conveyor further comprising a slanted transition conveyor section, a first upward conveyor section, and a first downward conveyor section;
the slanted transition conveyor section, the first upward conveyor section, and the first downward conveyor section being serially positioned along the motorized belt conveyor;
the slanted transition conveyor section, the first upward conveyor section, and the first downward conveyor section being positioned in between the skewer-molding mechanism and the second conveyor end; and
the at least one heating device being in thermal communication with the first downward conveyor section.

11. The automated skewer grill as claimed in claim 10 further comprising:
the motorized belt conveyor further comprising a second upward conveyor section and a second downward conveyor section;
the second upward conveyor section and the second downward conveyor section being serially positioned along the motorized belt conveyor;
the second upward conveyor section and the second downward conveyor section being positioned in between the first downward conveyor section and the second conveyor end; and
the at least one heating device being in thermal communication with the second upward conveyor section.

12. The automated skewer grill as claimed in claim 10 further comprising:
a waste collection tray;
the waste collection tray being mounted onto the vertical frame portion, offset from the motorized belt conveyor; and
the waste collection tray being positioned in between the first upward conveyor section and the second conveyor end.

13. The automated skewer grill as claimed in claim 1 further comprising:
the at least one heating device comprising a first heating portion and a second heating portion;
the first heating portion being positioned adjacent to the motorized belt conveyor; and
the second heating portion being positioned adjacent to the motorized belt conveyor, opposite to the first heating portion.

14. The automated skewer grill as claimed in claim 1 further comprising:
a plurality of skewer clips;
each of the plurality of skewer clips being connected onto the motorized belt conveyor; and
the plurality of skewer clips being evenly distributed along the motorized belt conveyor.

15. The automated skewer grill as claimed in claim 14 further comprising:
each of the plurality of skewer clips comprising a C-shaped clip section, an intermediate clip section, a reverse-C-shaped clip section, and an extension clip section;
the extension clip section being positioned perpendicular to the intermediate clip section;
the intermediate clip section being connected in between the C-shaped clip section and the reverse-C-shaped clip section;
the extension clip section being connected onto the reverse-C-shaped section; and
the extension clip section and the intermediate clip section being positioned offset from each other about the reverse-C-shaped section.
